(19) United States
(12) Patent Application Publication
(10) Pub. No.: US 2012/0245951 A1
(43) Pub. Date: Sep. 27, 2012

(54) SYSTEM AND METHOD FOR COMPLIANCE REWARD

(76) Inventors: Jonathan Peter Gips, Central (HK); Philip Angus Liang, Wong Chuk Hang (HK); Aaron Douglas Valade, Pok Fu Lam (HK); Eric Leuthardt, St. Louis, MO (US)

(21) Appl. No.: 13/428,260

(22) Filed: Mar. 23, 2012

Related U.S. Application Data
(60) Provisional application No. 61/466,692, filed on Mar. 23, 2011.

(51) Int. Cl. G06Q 30/02; G06Q 50/22

(52) U.S. Cl. 705/2; 705/14.1

(57) ABSTRACT

Systems and methods for rewarding compliance are disclosed. In one embodiment, compliance data is received from a compliance monitoring system. The compliance data includes an indication of compliance success or compliance failure associated with an event having an associated compliance action. A compliance measurement is determined based on, at least in part, the compliance data. A compliance point value associated with the compliance measurement is determined based on, at least in part, an incentive. A reward is provided based on, at least in part, the compliance point value associated with the compliance measurement. Other systems and methods are disclosed.

### CROSS-REFERENCE TO RELATED APPLICATIONS

This application claims the benefit of U.S. provisional patent application Ser. No. 61/466,692, entitled “Compliance Reward System,” filed on 23 Mar. 2011, the entire disclosure of which is incorporated herein by reference.

### TECHNICAL FIELD

The present disclosure generally relates to promoting compliance, and more particularly relates to a system for rewarding compliance.

### BACKGROUND

Many businesses and institutions require employees to comply with various procedures or policies in order to promote positive outcomes. For example, hospitals that follow the World Health Organization's “Five Moments for Hand Hygiene” guidelines ask their employees to perform hand hygiene whenever any one of a set of conditions is met during the course of an employee's duties. Complying with such guidelines may help protect patients and employees alike by reducing the spread of infection causing fomites across critical boundaries inside the hospital and patient areas. Unfortunately, even when employees recognize the importance of complying with procedures and guidelines, often the demands of the employees' jobs and the additional burdens of complying with such procedures and guidelines result in levels of compliance that are below desired goals.

### SUMMARY OF THE DISCLOSURE

According to one implementation, a computer implemented method includes receiving compliance data from a compliance monitoring system. The compliance data may include an indication of compliance success or compliance failure associated with an event having an associated compliance action. A compliance measurement may be determined based on, at least in part, the compliance data. A compliance point value associated with the compliance measurement may be determined based on, at least in part, an incentive. A reward may be provided based on, at least in part, the compliance point value associated with the compliance measurement.

One or more of the following features may be included. The compliance action may include performance of hand hygiene. The compliance action may include conducting patient rounds. The compliance data may include contextual information associated with one or more of the event and the compliance action.

The compliance measurement may be based on, at least in part, cumulative compliance successes. The compliance measurement may be based on, at least in part, a ratio of compliance success and compliance failure. The compliance measurement may be associated with an individual. The compliance measurement may be associated with a group.

The incentive may include one or more of a compliance success weighting factor and a compliance failure weighting factor. The incentive may be based on, at least in part, a compliance threshold. The compliance point may be determined based on, at least in part, the compliance threshold. The incentive may be based on, at least in part, a compliance rule defining the event and the associated compliance action. The incentive may be based on, at least in part, a random selection of a sample of compliance data. The reward may include one or more of a compliance recognition and a redeemable value.

According to another implementation, a computer implemented method includes receiving compliance data from a hand hygiene compliance monitoring system. The compliance data may include an indication of compliance success or compliance failure associated with a hand hygiene opportunity. A compliance measurement may be determined based on, at least in part, the compliance data. A compliance point value associated with the compliance measurement may be determined based on, at least in part, an incentive. A reward may be provided based on, at least in part, the compliance point value associated with the compliance measurement.

One or more of the following features may be included. The compliance data may include contextual information associated with hand hygiene opportunity. The compliance measurement may be associated with an individual. The compliance measurement may be associated with a group.

The incentive may include one or more of a compliance success weighting factor and a compliance failure weighting factor. The incentive may be based on, at least in part, a compliance threshold. The incentive may be based on, at least in part, a compliance rule defining the hand hygiene opportunity.

According to yet another implementation, a system may include a compliance monitoring system including a first detection device and a second detection device configured to detect a compliance event and generate compliance data indicating compliance success or compliance failure of a compliance action associated with the compliance event. At least one processor may be configured to receive the compliance data from the compliance monitoring system. The at least one process may also be configured to determine a compliance measurement based on, at least in part, the compliance data. The at least one processor may also be configured to determine a compliance point value associated with the compliance measurement based on, at least in part, an incentive. The at least one processor may further be configured to provide a reward based on, at least in part, the compliance point value associated with the compliance measurement.

The following feature may also be included. The incentive may be based on, at least in part, a compliance rule defining the compliance event and the associated compliance action.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a compliance reward process coupled to a distributed computing network.

FIG. 2 is a flowchart of a process executed by the compliance reward process of FIG. 1.

### DETAILED DESCRIPTION OF EXAMPLE EMBODIMENTS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

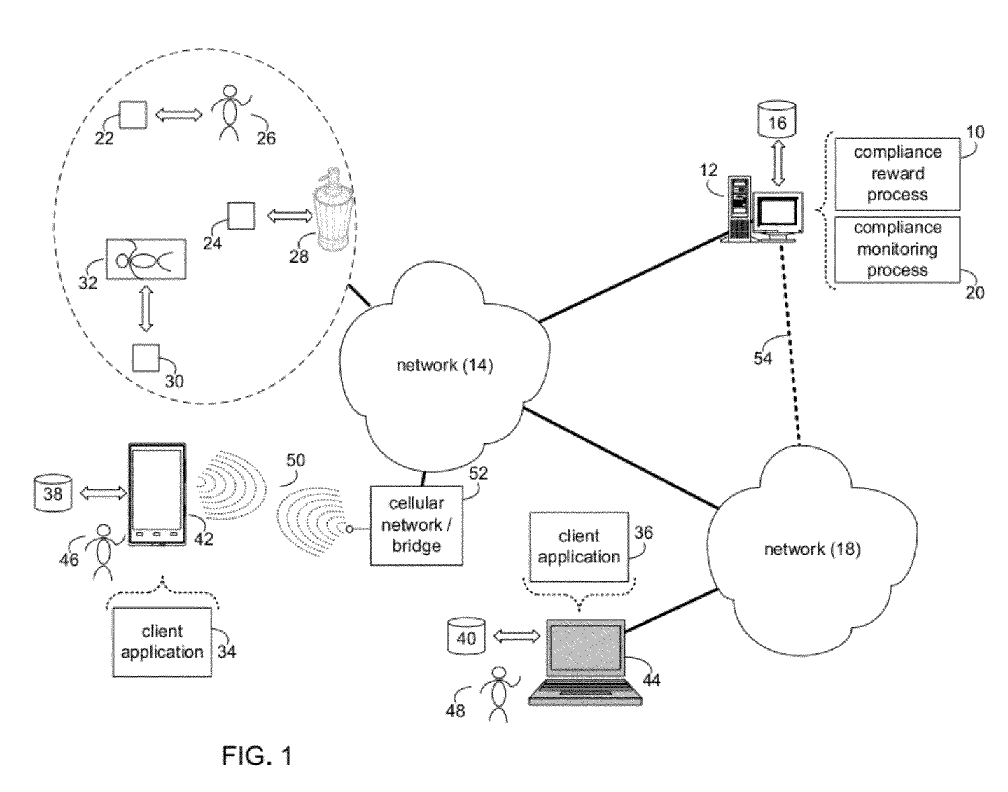

Referring to FIG. 1, there is shown compliance reward process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.)

As will be discussed below in greater detail, compliance reward process 10 may receive compliance data from a compliance monitoring system. The compliance data may include an indication of compliance success or compliance failure associated with an event having an associated compliance action. The compliance reward process 10 may determine a compliance measurement based on, at least in part, the compliance data. The compliance reward process 10 may determine a compliance point value associated with the compliance measurement based on, at least in part, an incentive. The compliance reward process 10 may also provide a reward based on, at least in part, the compliance point value associated with the compliance measurement. Accordingly, the compliance reward process 10 may incentivize compliance with guidelines by providing positive reinforcement for compliance. In some embodiments, the compliance reward process 10 may serve to recognize the importance of compliance and the cost of compliance to the individuals.

The instruction sets and subroutines of compliance reward process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute a web server application, examples of which may include but are not limited to: Microsoft IIS, Novell Webserver™, or Apache® Tomcat®, that allows for HTTP (i.e., HyperText Transfer Protocol) access to server computer 12 via network 14 (Webserver is a trademark of Novell Corporation in the United States, other countries, or both; and Apache and Tomcat are registered trademarks of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute compliance monitoring process 20, which may, for example, be part of a compliance monitoring system that may receive inputs from one or more receive inputs from one or more detection devices and may generate compliance data. The compliance data may, for example, indicate compliance success and/or compliance failure associated with an event having an associated compliance action. The instruction sets and subroutines of compliance monitoring process 20, which may be stored on storage device 16 coupled to server computer 12 may be executed by one or more processors (not shown) and one or more memory modules (not shown) incorporated into server computer 12. An example of a compliance monitoring system is disclosed in U.S. patent application Ser. No. 12/756,811, entitled “Reducing Medical Error,” filed on 8 Apr. 2010, the entire disclosure of which is incorporated herein by reference.

In an illustrative example, the compliance monitoring system may be utilized in connection with a hand hygiene compliance guideline. The compliance monitoring system may include, for example, first detection device 22 and second detection device 24, through which the compliance monitoring system may be configured to detect a compliance event and generate compliance data indicating compliance success or compliance failure of a compliance action associated with the compliance event. In the illustrative embodiment first detection device 22 may be configured to receive a signal from another detection device (e.g., second detection device 24), and may be configured to record data associated with the received signal, and/or upload data associated with the received signal to, e.g., compliance monitoring process 20. First detection device 22 may, for example, be associated with an identification badge, or other item, that may be carried by user 26. Second detection device 24 may include a transmitter, e.g., which may transmit a signal (e.g., a radio frequency signal, an optical signal, an electrical signal, or the like) that may be received by first detection device 22. Second detection device 24 may be associated, for example, with hand hygiene dispenser 28, a glove dispenser, etc. In some embodiments, second detection device 24 may include an indicator (e.g., a serial number, coded sequence, or the like) associating second detection device 24 with dispenser 28, a general location (e.g., a location associated with dispenser 28, one or more rooms proximate dispenser 28, or the like). In an embodiment, second detection device 24, and/or another detection device associated with the compliance monitoring system, may include a dispense detection device that may, e.g., detect actuation of the hand hygiene dispenser. Second detection device 24 may be configured to, e.g., provide an output in response to proximate detected actuation of hand hygiene dispenser 28 associated with second detection device 24. In an embodiment, the compliance monitoring system may include one or more additional detection devices. For example, in the illustrated example, third detection device 30 may be associated with patient bed 32. Third detection device 30 may include, for example, a beacon that may be configured to, e.g., intermittently and/or continuously provide an output (e.g., a transmission that may, for example, include a zone identification, or the like) that may be received by first detection device 22, e.g., when first detection device is located in an area proximate patient bed 32.

Consistent with the illustrated example compliance monitoring system, second detection device 24 may provide an output in response to a detected actuation of hand hygiene dispenser 28. Similarly, third detection device 30 may provide an output associated with a region proximate patient bed 32. Consistent with the illustrated embodiment, the example compliance monitoring system may be configured to provide an indication of user 26 conducting, or not conducting, hand hygiene (e.g., based on first detection device 22 receiving a transmitted signal from second detection device 24 generally contemporaneously with an actuation of hand hygiene dispenser 28) prior to contact with a patient in patient bed 32 (e.g., based on first detection device being proximate to third detection device 30, and receiving a transmitted signal from third detection device 30) and/or providing an indication of user 26 conducting, or not conducting, hand hygiene after contact with the patient in patient bed 32 (e.g., in a corresponding manner).

In addition/as an alternative to the first detection device being configured to receive a signal from one or more additional detection devices, the first detection device may include, for example a transceiver (such as an RFID device, or other similar detection device), which may, for example, be interrogated by one or more additional detection devices. In such an example embodiment, upon the first detection device being in proximity with another detection device, the first detection device may be interrogated by the other detection device. In response to being interrogated by the other detection device, the first detection device may, for example, transmit an identification code (such as a serial number, employee identification number, or the like), e.g., which may be received by the other detection device. Various additional and/or alternative system configurations may be equally utilized

While the preceding example compliance monitoring system is configured to detect compliance success or compliance failure with a hand hygiene guideline (e.g., requiring hand hygiene prior to, or following, contact with a patient), the illustrated compliance monitoring system is intended for the purpose of illustration only, and should not be construed as a limitation on the present disclosure as other compliance monitoring systems may be equally utilized. For example, in addition to hand washing/disinfection (e.g., which may be provided by a hand hygiene product dispensed by the hand hygiene dispenser of the example system), hand hygiene may also include the use of gloves (e.g., which may be dispensed by a glove dispenser apparatus). Similarly, a hand hygiene compliance system may include an alcohol foam/cleanser dispenser, a paper towel dispenser, a hand moisturizer/sanitizer dispenser, operating room soap dispenser, radiant energy (e.g., UV irradiation) sterilization device, or the like. Further, in some embodiments, a duration component may also be detected by the compliance system (e.g., based on a time of proximity of the first detection device with the hand hygiene device, a duration of usage of the hand hygiene device, etc.). In a similar manner, a compliance monitoring system may be associated with a gown dispenser device, or the like. For example, in the healthcare environment, compliance monitoring systems may be implemented to monitor timely delivery of patient medications, patient checks (e.g., taking patient vital information, and condition assessments, or the like).

In further embodiments, a compliance monitoring system may be implemented in connection with a system for monitoring patient mobilization. For example, after a number of orthopedic surgeries, recovery may be based on, at least in part, how rapidly and how often a patient is mobilized via physically therapy. Such mobilization may play an important role in allowing patients to be discharged sooner. Since length of patient stay in a treatment facility may make a significant difference to level of reimbursement, monitoring and promoting compliance with a patient mobilization guideline may allow an orthopedic specialty hospital to achieve rapid throughput, and therefore improved profit margins. In another example embodiment, compliance may be monitored associated with documentation of physical presence in an operating room may be monitored. For example, growing medical-legal and federal attention is being paid to medical professions billing appropriately. Some examples may include monitoring compliance to verify that a doctor was present in an operating room at the times the doctor said he was in the operating room. In a related embodiment, a compliance monitoring system may be utilized in connection with billing associated with an Intensive Care Units (ICU). For example, when an intensivist is making rounds in the ICU, the intensivist may bill for the time spend on each patient. When the intensivist dictates their notes, they dictate the amount of time they spend with each patient for appropriate reimbursement. In an example embodiment, a compliance monitoring system may be utilized to log data regarding an amount of time the intensivist spent with each patient, e.g., which may allow for more efficient billing and reimbursement. In various additional/alternative embodiments, a compliance monitoring system may be utilized in connection with guidelines associated with operating room turnover (e.g., how rapidly nursing and maintenance staff turn a room over for the next surgical case), proper usage of portable x-ray machines (e.g., guidelines associated with the safe operation of portable x-ray machines, such healthcare workers leaving the vicinity of the x-ray machine during operation, etc.), medication delivery, and the like.

Various additional/alternative compliance monitoring systems may also be implemented to monitor compliance with guidelines in industries other than healthcare. For example, a compliance monitoring system may be implemented in connection with guidelines associated with hand hygiene in the food industry, with guidelines associated with hazardous material handling, and the like.

Compliance reward process 10 may be a stand alone application, or may be an applet/application/script that may interact with and/or be executed within compliance monitoring process 20. In addition/as an alternative to being a server-side process, the compliance reward process and/or the compliance monitoring process may be a client-side process (not shown) that may reside on a client electronic device (described below). Further, the compliance reward process and/or the compliance monitoring process may be a hybrid server-side/client-side process. As such, the compliance reward process and/or the compliance monitoring process may reside, in whole, or in part, on server computer 12 and/or one or more client electronic devices.

In an embodiment, a client application (e.g., one or more of client applications 34, 36) may interact with compliance reward process 10 and/or compliance monitoring process 20. The instruction sets and subroutines of client applications 34, 36, which may be stored on storage devices 38, 40 (respectively) coupled to client electronic devices 42, 44 (respectively), may be executed by one or more processors (not shown) and one or more memory modules (not shown) incorporated into client electronic devices 42, 44 (respectively). Client applications 34, 36 may include, for example, a web browser (e.g., Safari, by Apple Inc., Chrome by Google Inc., or the like) and/or a custom application. Storage devices 38, 40 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 42, 44 may include, but are not limited to, mobile computing device 42 (such as a smart phone, netbook, tablet computer or the like), notebook computer 44, for example. Each of client electronic devices 42, 44 may execute an appropriate operating system, for example, Mac OS, iOS, Android OS, Windows, or other suitable operating system. (Mac OS is a trademark of Apple Inc. in the United States, other countries, or both; iOS is a trademark of Cisco Systems, Inc.; Android is a trademark of Google Inc. in the United States, other countries, or both; Windows is a trademark of Microsoft Corporation in the United Sates, other countries, or both.)

Using client applications 34, 36, users 46, 48 may access compliance reward process 10 and/or compliance monitoring process 20 and may allow users to e.g., manage compliance rewards, compliance guidelines, and the like. Users 46, 48 may access compliance reward process 10 and/or compliance monitoring process 20 directly through the device on which the client application (e.g., client applications 34, 36) is executed, namely client electronic devices 38, 40 for example. Users 46, 48 may access compliance reward process 10 and/or compliance monitoring process 20 directly through network 14 or through secondary network 18. Further, server computer 12 (i.e., the computer that executes compliance monitoring process 20) may be connected to network 14 through secondary network 18, as illustrated with phantom link line 54.

The various client electronic devices may be directly or indirectly coupled to network 14 (or network 18). For example, mobile computing device 42 is shown wirelessly coupled to network 14 via wireless communication channel 50 established between mobile computing device 42 and cellular network/bridge 52, which is shown directly coupled to network 14. In addition/as an alternative to a cellular wireless communication channel, mobile computing device may be wirelessly connected to a wireless access point (i.e., WAP), which is shown directly coupled to network 14. The WAP may be, for example, an IEEE 802.11a, 802.11b, 802.11g, Wi-Fi, and/or Bluetooth device that is capable of establishing wireless communication channel between mobile computing device 42 and the WAP. Further, notebook computer 44 is shown directly coupled to network 18 via a hardwired network connection.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

In the following description, implementations may be described in the context of a healthcare environment, and/or in the context of compliance with hand hygiene guidelines. However, such description is provided only for the purpose of illustration, and should not be construed as a limitation on the instant disclosure. It will be appreciated that the systems and methods described in the instant disclosure are susceptible to wider application.

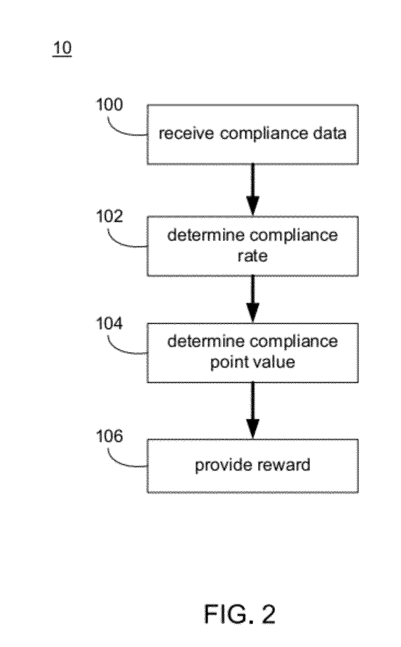

Referring also to FIG. 2, compliance reward process 10 may receive 100 compliance data from a compliance monitoring system. The compliance data may include an indication of compliance success or compliance failure associated with an event having an associated compliance action. The compliance reward process 10 may determine 102 a compliance measurement based on, at least in part, the compliance data. The compliance reward process 10 may determine 104 a compliance point value associated with the compliance measurement based on, at least in part, an incentive. The compliance reward process 10 may also provide 106 a reward based on, at least in part, the compliance point value associated with the compliance measurement. Accordingly, the compliance reward process 10 may incentivize compliance with guidelines by providing positive reinforcement for compliance. In some embodiments, the compliance reward process 10 may serve to recognize the importance of compliance and the cost of compliance to the individuals.

For example, compliance reward process 10 may receive 100 compliance data from the compliance monitoring system (e.g., via compliance monitoring process 20 and/or directly from one or more compliance detection devices 22, 24, 30). The compliance data may include an indication of compliance success or compliance failure associated with an event having an associated compliance action. For example, a hand hygiene guideline may specify that an employee (e.g., user 26) should conduct hand hygiene before and after coming in contact with a patient. Accordingly, first detection device 22 (and thereby user 26) detect proximity with patient bed 32, based upon a signal transmitted by detection device 30, which may be indicative of user 26 coming into contact with the patient. Additionally, first detection device 22 may receive a signal from second detection device 24, thereby indicating the presence of user 26 within proximity of hand hygiene dispenser 28, within a time interval (e.g., 30 seconds, one minute, or another time interval) prior to user 26 coming within proximity of third detection device 30. Reception of the signal from second detection device 24 may be based on, at least in part, the actuation of hand hygiene dispenser 28, which may be indicative of user 26 conducting hand hygiene. Additionally, first detection device 22 may also receive a signal from second detection device 24 (e.g., which may indicate user 26 in proximity to second detection device 24, and therein proximity to hand hygiene dispenser 28) within a time interval (e.g., 30 seconds, one minute, or other time interval) after leaving proximity to third detection device 30 (and therein patient bed 32). Further, in some embodiments, reception of the signal from second detection device 24 may be based on, at least in part, actuation of hand hygiene dispenser 28, which may be indicative of user 26 conducting hand hygiene after coming into contact with the patient.

Based on the proximity of user 26 to hand hygiene dispenser 28 (e.g., and also actuation of hand hygiene dispenser 28) in a time interval prior to coming into proximity to patient bed 32, the compliance monitoring system may generate a first compliance data indicative of user 26 performing the compliance action of hand hygiene prior to the event of coming into contact with a patient. Accordingly, the first compliance data may indicate compliance success by user 26 with the guideline recommending hand hygiene prior to coming into contact with a patient. Similarly, based on the proximity of user 26 to hand hygiene dispenser 28 (e.g., and also actuation of hand hygiene dispenser 28) in a time interval after leaving proximity to patient bed 32, the compliance monitoring system may generate a second compliance data indicative of user 26 performing hand hygiene after coming into contact with a patient. Accordingly, the second compliance data may also indicate compliance success by user 26 with the guideline recommending hand hygiene after coming into contact with the patient. Compliance reward process 10 may receive 100 the first and second compliance data from the compliance monitoring system (e.g., from compliance monitoring process 20).

In some embodiments, the compliance data may include rich compliance data, e.g., which may include contextual information associated with one or more of the event and the compliance action, in addition to an indication of compliance success or compliance failure and identifying the individual (e.g., user 26). For example, one or more of the first compliance data and the second compliance data may include an identification of the compliance rule (e.g., performance of hand hygiene before coming in contact with a patient, and performance of hand hygiene after coming in contact with a patient). The compliance data may also include a time stamp (e.g., an actual time, a shift identification, or other relative time indicator) indicating the timing of the compliance event and/or the compliance action.

The compliance data may include additional/alternative contextual information. For example, the compliance data may include an indication that the patient associated with patient bed 32 may be an immune compromised patient, a patient having an infectious condition (e.g., MRSA, etc.), and identification of the location (e.g., bed number, ward, floor, department, or the like), as well as various additional contextual information regarding the compliance rule, the event, and/or the compliance action. In some embodiments, one or more of the compliance event and the compliance action of the first compliance data and the second compliance data may be at least partially overlapping. For example, in the above described example, the compliance event (e.g., contact with a patient) may be the same for both the first compliance data and the second compliance data. In other examples, the entirety of at least one compliance data may overlap with at least a portion of another compliance data. For example, a guideline recommending that a patient be checked every 20 minutes may overlap with the requirement that an employee perform hand hygiene prior to coming into contact with a patient. The compliance monitoring system may generate a the first compliance data indicating that user 26 has performed hand hygiene prior to coming into contact with a patient, and the compliance monitoring system may generate a third compliance data indicating that user 26 has checked on the patient associated with patient bed 32. Additional/alternative contextual information may include, for example, patient zone information, identification of a contact isolation room, time of day, role of the user (e.g., doctor, nurse, physiotherapist, etc.).

Compliance reward process 10 may determine 102 a compliance measurement, based on, at least in part, the compliance data. The compliance measurement may include, for example, a number of compliance successes and a number of compliance failures. In some embodiments, compliance reward process 10 may associate the number of compliance successes and compliance failures with one or more of an individual user, a compliance rule, a time, and/or other contextual information.

In an embodiment, the compliance measurement may be based on, at least in part, cumulative compliance success. For example, the compliance measurement based on cumulative successes may include a count of the total number of determined compliance successes. In some embodiments, the compliance measurement may be based on, at least in part, a ratio of compliance success and compliance failures. For example, the compliance measurement may include a ratio of compliance successes to compliance failures or a ratio of compliance successes to a total number of compliance opportunities (i.e., a total number of events having an associated compliance action). In some embodiments, the ratio of compliance successes to a total number of compliance opportunities may include a percentage of compliance successes relative to the total number of compliance opportunities.

In some embodiments, compliance reward process 10 may determine 102 the compliance measurement relative to a threshold value. For example, the threshold value may include a target and/or desired level of compliance. The compliance threshold may include, for example, a desired total number of compliance successes. The threshold total number of compliance successes may be based on, for example, a defined time frame (e.g., 30 compliance successes per day, or the like). Additionally/alternatively, the compliance threshold may include a relative level of compliance. For example, in the context of hand hygiene within a healthcare environment, it may be determined that a level of hand hygiene compliance greater than 70% (e.g., 70% compliance success relative to the total number of compliance opportunities) may provide diminished returns for controlling the spread of disease or infection. Accordingly, in an embodiment the threshold value may be 70% compliance. In some embodiments, compliance reward process 10 may determine the compliance measurement relative to the threshold value as a binary outcome. For example, a compliance measurement less than the threshold may be determined to be a failing compliance measurement. Correspondingly, a compliance measurement equal to, or greater than, the threshold compliance measurement may be determined to be a passing compliance measurement. Various additional/alternative implementations may be equally utilized.

In an embodiment, the threshold value may be for all compliance events. In some embodiments, different compliance thresholds may be associated with different compliance rules and/or compliance guidelines. For example, in the foregoing example, the 70% compliance with hand hygiene may be a threshold may be a general or overall compliance threshold for the example healthcare environment. However, in some situations, a higher threshold value may be desirable. The higher threshold value may be associated with one or more individual compliance guidelines or compliance rules and/or may be associated with one or more pieces of contextual information included within the compliance data. For example, a higher level of threshold compliance (e.g., a 90% threshold compliance) may be desirable for, e.g., patients having a contagious disease, patient's who are immune compromised, for specific individuals (e.g., emergency care workers), etc. According to such an example, a 70% hand hygiene compliance rate may be a passing compliance measurement for general contact with patients, but may be a failing compliance measurement for contact with immune compromised patients. It will be appreciated that the foregoing examples have been provided for the purpose of illustration, and not of limitation. Various additional/alternative implementations may be equally utilized. For example, threshold compliance values may be further delineated and/or associated with contextual information included within the compliance data. For example, a higher level of hand hygiene may be recommended prior to contact with an immune compromised patient than may be recommended following contact with an immune compromised patient, etc.

The compliance reward process 10 may determine 102 the compliance measurement associated with an individual user. In such an embodiment, the compliance measurement may be indicative of the performance of the individual user with respect to the monitored compliance events. Additionally/alternatively, the compliance reward process 10 may determine 102 the compliance measurement associated with a group of individuals. For example, the group may include more than one individual having a common association (e.g., members of the same department, members of a team, individuals working on the same floor, and/or any subset of individuals subject to compliance monitoring, including all individuals subject to compliance monitoring). In such an embodiment, the compliance measurement may be indicative of the performance of the group with regard to the monitored compliance events.

A compliance measurement associated with a group of individuals may, for example, provide an indication of the performance of the group (e.g., a department) with respect to the monitored compliance events (e.g., and therefore with respect to a compliance policy or compliance guidelines). In addition/as an alternative to providing an indication of the performance of the group, the compliance guideline may include guideline that may a compliance action that may be primarily relevant in the performance of the compliance action in general, rather than performance of the compliance action by an individual. For example, a guideline may recommend that every patient within a ward is checked on by a nurse every twenty minutes. Accordingly, performance of the compliance action may not require performance by a particular individual, but rather only requires performance of the compliance action. In some embodiments, a compliance measurement associated with a group of individuals may improve compliance, e.g., by promoting team work, by promoting competition among groups, through peer pressure, or the like. In an embodiment, compliance reward process 10 may determine 102 the group compliance measurement as the number of compliance successes by all members of the group, as an average number of compliance successes by all of the members of the group, as the lowest number of compliance successes by any member of the group, or the like. Additionally, compliance reward process 10 may determine 102 the compliance measurement as a ratio or percentage of compliance successes, as a number of compliance successes over a period of time, and/or relative to a threshold value.

Compliance reward process 10 may determine 104 a compliance point value associated with the compliance measurement based on, at least in part, an incentive. In some embodiments, the incentive may be based on, at least in part, a cumulative compliance measurement. For example, the incentive may include a count of the total number of compliance successes. In such an embodiment, compliance reward process 10 may determine 104 a compliance point value associated with the compliance measurement. In one such example, for a determined 102 compliance measurement of five compliance successes, compliance reward process 10 may determine 104 a compliance point value of five. As such, in an example embodiment, determining a compliance point value associated with the compliance measurement may include determining a count of the number of compliance successes. As will be discussed in greater detail below, the compliance point value may be scaled. In some embodiments, the incentive may include a random attribution of a compliance point and/or compliance point value. For example, determining 104 a compliance point value based on, at least in part, an incentive may include randomly determining a compliance point value for a given compliance measurement, determining a compliance point value for a random number of compliance successes (e.g., which may be associated with a plurality of individual users and/or groups), and/or randomly determining a point value (e.g., between a predetermined maximum and minimum, or the like) for a given compliance success, and/or otherwise randomly determining a compliance point value associated with a compliance measurement. In such an embodiment, the uncertainty of a point value award may be utilized as a motivator for compliance. For example, if a user does not know when a compliance success will be rewarded, the user may be motivated to pursue a relatively high compliance measurement in the hope of attaining a compliance point value.

In some embodiments, the incentive may include an algorithm for determining 104 a compliance point value from a determined compliance measurement. For example, the incentive may include one or more of a compliance success weighting factor and a compliance failure weighting factor. For example, compliance reward process 10 may determine a compliance point value according to the formula:

Point=Ws*compliance success+Wf*compliance failure

Wherein Ws may be a compliance success weighting factor and Wf may be a compliance failure weighting factor.

In an example embodiment, a compliance success may have a positive one weighting factor, and a compliance failure may have a negative one weighting factor. In such an embodiment, a point value may be determined 104 as a number of compliance successes plus the negative number of compliance failures (e.g., the difference between the number of compliance successes and compliance failures). Other weighting factors may also be utilized. For example a compliance success weighting factor may be equal to two, and a compliance failure weighting factor may be equal to negative one. Accordingly, compliance reward process 10 may determine 104 two points for every compliance success and penalize a compliance failure with a loss of one point. Various additional/alternative weighting factors may also be utilized.

In some embodiments, the weighting factor may be based on, at least in part, a number of compliance successes and/or compliance failures. Accordingly, the weighting of compliance successes and/or compliance failures may vary based on performance. For example, a compliance success weighting factor of one may be utilized for ten or fewer compliance successes, a compliance weighting factor of two may be utilized for between eleven and twenty compliance successes, and a compliance success weighting factor of three may be utilized for twenty-one or greater compliance successes. Compliance failure weighting factors may be similarly utilized.

The incentive may be based on, at least in part, a compliance rule defining the event and the associated compliance action. For example, in some embodiments, the compliance success weighting factor and/or the compliance failure weighting factor may vary depending upon the compliance guideline and/or contextual information associated with the compliance data. For example, some compliance actions may be considered to be more important or crucial than other compliance actions. Referring to the above-example of hand hygiene, while a guideline may recommend performance of hand hygiene before coming in contact with a patient and after coming in contact with a patient, it may be deemed very important to perform hand hygiene before coming in contact with an immune compromised patient. Similarly, it may be deemed very important to perform hand hygiene after coming in contact with a patient having an infectious condition, such as MRSA. In an example, a compliance success weighting factor of one and a compliance failure weighting factor of negative one may be applied to hand hygiene compliance for patients that are not immune compromised and/or patients not having an infectious condition. Further a compliance success weighting factor of one and a compliance failure weighting factor of minus two may be applied to hand hygiene prior to coming into contact with an immune compromised patient and/or to hand hygiene after coming into contact with a patient having an infectious condition. Similarly, different compliance thresholds may be associated with different rules, and/or different circumstances (e.g., indicated by the contextual information associated with the compliance data). The compliance success weighting factor and/or the compliance failure weighting factor, and/or any various based on different guidelines and/or contextual information may be defined, for example, by an administrator.

In some embodiments, the incentive may be based on, at least in part, a compliance threshold. In such an embodiment, the compliance point may be determined based on, at least in part, the compliance threshold. For example, the incentive may be based upon a lookup table. The lookup table may define one or more threshold values (and/or ranges) and one or more compliance point values associated with each of the one or more threshold values. For example, for a zero point value may be associated with a threshold compliance value less than 70%; a one point value may be associated with a threshold compliance value between 70% and 75%; a two point value may be associated with a threshold compliance value between 76% and 85%; and a three point value may be associated with a threshold compliance value of 86% or greater. Accordingly, for a determined 102 compliance rate of 77%, compliance reward process 10 may determine 104 a compliance point value of two. Other point values may similarly be determined 104. Further, different point values may be associated with threshold compliance values based on, at least in part, different guidelines and/or contextual information associated with the compliance data.

In some embodiments, the point values may be normalized and/or scaled. For example, a multiplier may be applied to the point values to change the general range of the point values. The multiplier applied to the point values may, for example, place the point values in the range of thousands, ten thousands, etc. Changing the scale of the point value, e.g., to a higher scale, may increase the psychological impact of the point values in terms of motivating compliance by individuals.

In an embodiment, benefits and/or recognition may be awarded to individuals based on, at least in part, the compliance point values achieved by the individuals, or groups to which the individuals belong. For example, individuals accruing a compliance point value indicative of a relatively high level of compliance (e.g., either in absolute terms, by comparison to a compliance threshold, and/or relative to other individuals) may receive a public recognition. For example, individuals accruing a compliance point value indicative of a relatively high level of compliance may be acknowledged via a visually distinct identification badge, such as first detection device 22 or another badge, (e.g., which may have a prominently distinct coloring, design, icon, or the like). The coloring, design, or icon may be determined by the system and/or an administrator. In some embodiments, the coloring, design, or icon may change over time. In some embodiments, individuals accruing a compliance point value indicative of a relatively high level of compliance may be acknowledged on an employee directory (e.g., which include a company or institution website, or the like). Various additional/alternative forms of recognition and/or acknowledgment may similarly be implemented.

According to an embodiment, compliance reward process 10 may provide 106 a reward (e.g., public recognition, etc.) based on, at least in part, an individual and/or group meeting a goal, target, or the like. For example, in an embodiment, an individual may receive public recognition for achieving compliance rate of 70% or greater for five work days in a row. In such an embodiment, the reward may either not be directly related to a point value, and/or meeting the goal, target, etc., may be in some manner correlated to the point value (e.g., a point value may be associated with meeting the goal, and the reward may be provided 106 based on the point value), etc.

In some embodiments, individuals may utilize accrued compliance point values to obtain benefits and/or rewards. For example, individuals may exchange at least a portion of their accrued compliance point value in exchange of benefits such a preferential shift selection, vacation priority, or other benefit. Further, in some embodiments individuals may utilize accrued compliance point values to obtain monetary and/or tangible rewards, such as consumer gift cards for use at shopping establishments, restaurants, coffee shops, or the like. Further, in some embodiments, individuals may utilize accrued compliance point values to acquire item such as consumer electronics, etc. It will be appreciated that the accrued compliance point values may otherwise be utilized to acquire benefits and/or rewards of various types.

In an embodiment, users (e.g., user 26, user 46, user 48) may utilize a client application (e.g., client applications 34, 36) executed by a client electronic device (e.g., client electronic device 38, 40) to access compliance reward process 10 for the purpose of managing the user's compliance points. For example, user 46 may utilize client application 34 executed on client electronic device 38 to access compliance reward process 10 to effectuate a purchase of a consumer gift care using user 46's accrued compliance point value, to view a balance of accrued compliance points, or the like. In other embodiments, compliance reward process 10 may be accessible, e.g., via and automated text messaging system, for the purpose of checking a user's accrued compliance point value, and/or purchasing rewards using the user's accrued compliance point value.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method comprising:
receiving, on a processor, compliance data from a compliance monitoring system, the compliance data including an indication of compliance success or compliance failure associated with an event having an associated compliance action;
determining, on the processor, a compliance measurement on, at least in part, the compliance data;
determining, on the processor, a compliance point value associated with the compliance measurement based on, at least in part, an incentive; and
providing, on the processor, a reward based on, at least in part, the compliance point value associated with the compliance measurement.

2. The computer implemented method of claim 1, wherein the compliance action includes performance of hand hygiene.

3. The computer implemented method of claim 1, wherein the compliance action includes conducting patient rounds.

4. The computer implemented method of claim 1, wherein the compliance data includes contextual information associated with one or more of the event and the compliance action.

5. The computer implemented method of claim 1, wherein the compliance measurement is based on, at least in part, cumulative compliance successes.

6. The computer implemented method of claim 1, wherein the compliance measurement is based on, at least in part, a ratio of compliance success and compliance failure.

7. The computer implemented method of claim 1, wherein the compliance measurement is associated with an individual.

8. The computer implemented method of claim 1, wherein the compliance measurement is associated with a group.

9. The computer implemented method of claim 1, wherein the incentive includes one or more of a compliance success weighting factor and a compliance failure weighting factor.

10. The computer implemented method of claim 1, wherein the incentive is based on, at least in part, a compliance threshold.

11. The computer implemented method of claim 10, wherein determining the compliance point is based on, at least in part, the compliance threshold.

12. The computer implemented method of claim 1, wherein the incentive is based on, at least in part, a compliance rule defining the event and the associated compliance action.

13. The computer implemented method of claim 1, wherein the incentive is based on, at least in part, a random selection of a sample of compliance data.

14. The computer implemented method of claim 1, wherein the reward may include one or more of a compliance recognition and a redeemable value.

15. A computer implemented method comprising:
receiving, on a processor, compliance data from a hand hygiene compliance monitoring system, the compliance data including an indication of compliance success or compliance failure associated with a hand hygiene opportunity;
determining, on the processor, a compliance measurement based on, at least in part, the compliance data;
determining, on the processor, a compliance point value associated with the compliance measurement based on, at least in part, an incentive; and
providing, on the processor, a reward based on, at least in part, the compliance point value associated with the compliance measurement.

16. The computer implemented method of claim 15, wherein the compliance data includes contextual information associated with hand hygiene opportunity.

17. The computer implemented method of claim 15, wherein the compliance measurement is associated with an individual.

18. The computer implemented method of claim 15, wherein the compliance measurement is associated with a group.

19. The computer implemented method of claim 15, wherein the incentive includes one or more of a compliance success weighting factor and a compliance failure weighting factor.

20. The computer implemented method of claim 15, wherein the incentive is based on, at least in part, a compliance threshold.

21. The computer implemented method of claim 15, wherein the incentive is based on, at least in part, a compliance rule defining the hand hygiene opportunity.

22. A system comprising
a compliance monitoring system including a first detection device and a second detection device configured to detect a compliance event and generate compliance data indicating compliance success or compliance failure of a compliance action associated with the compliance event;
at least one processor configured to:
receive the compliance data from the compliance monitoring system;
determine a compliance measurement based on, at least in part, the compliance data;
determine a compliance point value associated with the compliance measurement based on, at least in part, an incentive; and
provide a reward based on, at least in part, the compliance point value associated with the compliance measurement.

23. The system of claim 22, wherein the incentive is based on, at least in part, a compliance rule defining the compliance event and the associated compliance action.
